(19) United States
(12) Patent Application Publication
(10) Pub. No.: US 2025/0368201 A1
(43) Pub. Date: Dec. 4, 2025

(54) Using ISA System to Effect Driver Compliance with Fleet Policy

(71) Applicant: 7980302 Canada Inc., Montréal (CA)

(72) Inventors: Laurence Deschênes-Villeneuve, Laval (CA); Jonathan Lécuyer L'Espérance, LaSalle (CA); Gabriel Paquin Lefebvre, Montreal (CA)

(21) Appl. No.: 19/220,082

(22) Filed: May 28, 2025

Related U.S. Application Data
(60) Provisional application No. 63/652,659, filed on May 28, 2024.

(51) Int. Cl. B60W 30/14

(52) U.S. Cl. CPC B60W 30/146

(57) ABSTRACT

An intelligent speed adaptor (ISA) system of a fleet vehicle is configured to determine a reduced maximum speed limit instead of a maximum safe speed limit as being an applicable speed limit as a function of driver noncompliance. The reduced maximum speed limit is less than the maximum safe speed limit, at least in some situations. The driver noncompliance may be with respect to fleet policies regarding seatbelt usage, engine idling, and/or out-of-route travel.

### COPYRIGHT STATEMENT

Any new and original work of authorship in this document is subject to copyright protection under the copyright laws of the United States and other countries. Reproduction by anyone of this document as it appears in official governmental records is permitted, but otherwise all other copyright rights whatsoever are reserved.

### BACKGROUND OF THE INVENTION

The invention generally relates to intelligent speed adaptor (ISA) systems—or sometimes as intelligent speed adaptation systems or intelligent speed assistance systems. ISA systems are electronic speed management systems for vehicles designed to further compliance by drivers with speed limits. The vehicle may be a motor vehicle such as, for example, an automobile, truck, or semi-truck. It is further contemplated that at least some embodiments of the present invention have utilization with not only internal combustion motor vehicles but also electric vehicles. There are three general categories of ISA systems: open ISA systems: half-open ISA systems; and closed ISA systems (also referred to herein as active ISA systems). Open ISA systems (sometimes referred to herein as advisory ISA systems) provide an alert whether visible and/or audible to a driver when a speed limit is exceed and rely upon the driver to decrease the vehicle's speed; half-open ISA systems provide an alert and also temporarily limit the vehicle's capability to exceed the speed limit or make it more difficult to exceed the speed limit by the driver, such as by increasing the force countering depression of an accelerator pedal by a driver; and active ISA systems limit the speed automatically, overriding a driver's actions causing the speeding, such as by altering acceleration control signals that are sent from an accelerator pedal to an ECM. The present invention particularly relates to active ISA systems in which signals provided from an accelerator pedal sensor (APS) for receipt by an engine control module (ECM) are modified by an active ISA system in order to prevent a driver from driving the vehicle at a speed beyond a maximum safe speed limit. By modifying signals, when appropriate, the ISL system is able to avoid or at least minimize speeding of the vehicle.

Recent improvements in ISA systems are disclosed in Applicant's copending patent applications or granted patents, including U.S. patent application Ser. No. 16/947,456 and corresponding U.S. patent application publication 2021/0031765A1: U.S. patent application Ser. No. 16/947,458 and corresponding U.S. patent application publication 2021/0031782A1: U.S. patent application Ser. No. 17/004,661 and corresponding U.S. Pat. No. 11,572,067B2: U.S. patent application Ser. No. 17/330,869 and corresponding U.S. Pat. No. 11,702,083B2: U.S. patent application Ser. No. 18/428,235: and U.S. patent application Ser. No. 18/622,387. Each of the foregoing is incorporated herein by reference. Furthermore, any publication of or patent issuing from U.S. patent applications Ser. No. 18/428,235 and Ser. No. 18/622,387 is incorporated by reference herein.

Within the context of ISA systems and, more particularly, improved ISA systems as set forth in these patent applications and patents, it is believed that a need exists for a further improvement whereby driver compliance with fleet policies can be realized.

In this regard, for any vehicle fleet operator that is managing a large number of vehicles, ensuring each driver's compliance with policies of the fleet can be a real challenge. Examples of such policies include: a fleet's policy that a driver wear a seatbelt while driving: a fleet's policy that a driver not idle a vehicle above a certain threshold; and a fleet's policy that a driver follows a prescribed route. Typically, a fleet operator will use driver coaching in an attempt to ensure that its policies are followed, but there is little leverage in actively enforcing those policies. A need therefore exists for a tool for enforcing driver compliance with a fleet operator's various organization policies.

Such improvement is believed to be achieved by embodiments in accordance with one or more aspects and features of the present invention, now described below.

### SUMMARY OF THE INVENTION

The invention includes many aspects and features.

In an aspect, a vehicle comprises an intelligent speed adaptor (ISA) system that is configured to determine an applicable allowed speed limit for a given driving context based, in part, on driver compliance. The applicable allowed speed limit is less than what it would for a geofenced area if the driver is determined to be out of compliance.

In another aspect, a vehicle comprises an intelligent speed adaptor (ISA) system that is configured to determine an applicable allowed speed limit for a given driving context based, in part, on driver compliance. The applicable allowed speed limit is less than what it would for a given speed limit zone in a given driving context if the driver is determined to be out of compliance.

In a feature, compliance is determined with regard to seatbelt usage.

In a feature, compliance is determined with regard to cumulative idling of the engine over a given period of time.

In a feature, compliance is determined with regard to out-of-route travel distance of the vehicle over a given period of time.

In a feature, the vehicle is a fleet vehicle and compliance is determined based on a fleet policy as determined by a fleet operator.

In another aspect, a method of determining, by an ISA system, a reduced maximum speed limit instead of a maximum safe speed limit as being an applicable speed limit as a function of driver noncompliance is performed. A step of the method comprises determining noncompliance.

In a feature, the reduced maximum speed limit is less than the maximum safe speed limit.

In another aspect, an intelligent speed adaptor (ISA) system is configured to determine a reduced maximum speed limit instead of a maximum safe speed limit as being an applicable speed limit as a function of driver noncompliance. The ISA system may determine noncompliance or noncompliance may be determined remotely and communicated to the ISA system.

Another aspect comprises a vehicle having an intelligent speed adaptor (ISA) system as disclosed herein, including the incorporated references.

Another aspect comprises an intelligent speed adaptor (ISA) system as disclosed herein, including the incorporated references.

Another aspect comprises a method performed by an intelligent speed adaptor (ISA) system as disclosed herein, including the incorporated references.

Generally, in accordance with one or more aspects and features of the present invention, an improved ISA system is utilized in a fleet vehicle that is configured for enforcing driver compliance by applying a restrictive speed policy that is determined by the fleet and that is more restrictive than a speed policy that would otherwise be applied by the ISA system. The more restrictive speed policy would be applied when a driver is not in compliance with a given fleet's policy. Furthermore, as used herein, a “speed limit policy” is a predefined set of maximum speeds for each of a plurality of speed limits in speed zones of a predetermined driving context. A speed limit policy is established by the organization that owns the vehicle fleet, and a fleet ideally would have multiple speed limit policies that would apply for different driving contexts. In accordance with the invention, for a driving context a fleet could have an “maximum safe speed limit policy” and a “reduced maximum speed limit policy”, wherein the top speed of the vehicle would be determined by the reduced maximum speed limit policy and not by the maximum safe speed limit policy when the driver is not in compliance with one or more fleet policies. It is believed that this would incentivize the driver to comply with such policy for application of the maximum safe speed limit policy.

Many aspects and features also are disclosed in the drawings and accompany descriptions below, and in the appendix, incorporated herein by reference. Other aspects and features are disclosed in the patent applications, patent application publications, and patents incorporated above. Additionally, it should be noted that the invention further encompasses the various logical combinations and subcombinations of such aspects and features. Thus, for example, claims in this or a divisional or continuing patent application or applications may be separately directed to any aspect, feature, or embodiment disclosed herein, or combination thereof, without requiring any other aspect, feature, or embodiment.

### BRIEF DESCRIPTION OF THE DRAWINGS

One or more preferred embodiments of the invention now will be described in detail with reference to the accompanying drawings, wherein the same elements are referred to with the same reference numerals.

FIG. 1 illustrates a block diagram of a main architecture of a preferred ISA system utilized in a vehicle in accordance with one or more aspects and features of the invention.

FIG. 2 illustrates a workflow outlining use of an ISA system for effecting compliance with a fleet's seatbelt policy.

FIG. 3 illustrates a workflow outlining use of an ISA system for effecting compliance with a fleet's idling policy.

FIG. 4 illustrates an alternative workflow outlining use of an ISA system for effecting compliance with a fleet's idling policy.

FIG. 5 illustrates a workflow outlining use of an ISA system for effecting compliance with a fleet's out-of-route policy.

### DETAILED DESCRIPTION

As a preliminary matter, it will readily be understood by one having ordinary skill in the relevant art (“Ordinary Artisan”) that the invention has broad utility and application. Furthermore, any embodiment discussed and identified as being “preferred” is considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention disclosed herein: only one or a plurality of the features disclosed herein; or combination thereof. As such, many embodiments are implicitly disclosed herein and fall within the scope of what is regarded as the invention. Accordingly, while the invention is described herein in detail in relation to one or more embodiments, it is to be understood that this disclosure is illustrative and exemplary of the invention and is made merely for the purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. It is not intended that the scope of patent protection afforded the invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the invention. Accordingly, it is intended that the scope of patent protection afforded the invention be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

With regard solely to construction of any claim with respect to the United States, no claim element is to be interpreted under 35 U.S.C. 112(f) unless the explicit phrase “means for” or “step for” is actually used in such claim element, whereupon this statutory provision is intended to and should apply in the interpretation of such claim element. With regard to any method claim including a condition precedent step, such method requires the condition precedent to be met and the step to be performed at least once but not necessarily every time during performance of the claimed method.

Furthermore, it is important to note that, as used herein, “comprising” is open-ended insofar as that which follows such term is not exclusive. Additionally, “a” and “an” each generally denotes “at least one” but does not exclude a plurality unless the contextual use dictates otherwise. Thus, reference to “a picnic basket having an apple” is the same as “a picnic basket comprising an apple” and “a picnic basket including an apple”, each of which identically describes “a picnic basket having at least one apple” as well as “a picnic basket having apples”: the picnic basket further may contain one or more other items beside an apple. In contrast, reference to “a picnic basket having a single apple” describes “a picnic basket having only one apple”: the picnic basket further may contain one or more other items beside an apple. In contrast, “a picnic basket consisting of an apple” has only a single item contained therein, i.e., one apple: the picnic basket contains no other item.

When used herein to join a list of items, “or” denotes “at least one of the items” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers”: the picnic basket further may contain one or more other items beside cheese and crackers.

When used herein to join a list of items, “and” denotes “all of the items of the list”. Thus, reference to “a picnic basket having cheese and crackers” describes “a picnic basket having cheese, wherein the picnic basket further has crackers”, as well as describes “a picnic basket having crackers, wherein the picnic basket further has cheese”: the picnic basket further may contain one or more other items beside cheese and crackers.

The phrase “at least one” followed by a list of items joined by “and” denotes an item of the list but does not require every item of the list. Thus, “at least one of an apple and an orange” encompasses the following mutually exclusive scenarios: there is an apple but no orange: there is an orange but no apple: and there is both an apple and an orange. In these scenarios if there is an apple, there may be more than one apple, and if there is an orange, there may be more than one orange. Moreover, the phrase “one or more” followed by a list of items joined by “and” is the equivalent of “at least one” followed by the list of items joined by “and”.

One or more preferred embodiments of the invention are next described. The following description of one or more preferred embodiments is merely exemplary in nature and is in no way intended to limit the invention, its implementations, or uses.

### Main Architecture of a Preferred System

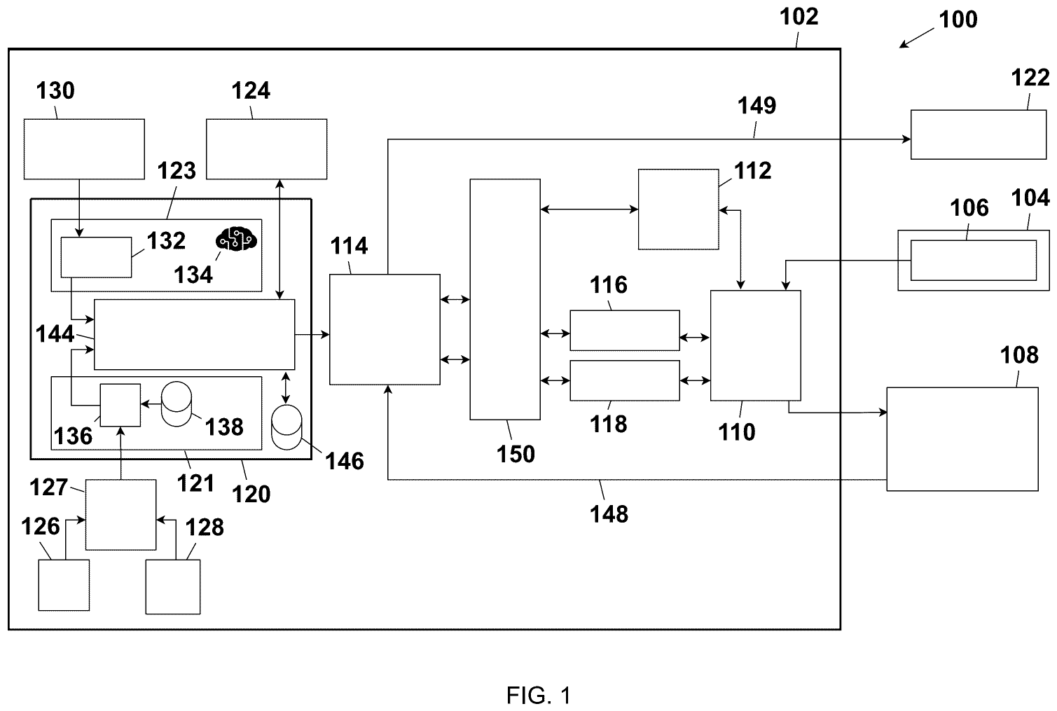

FIG. 1 illustrates a block diagram of a main architecture of a preferred ISA system 100 utilized in a vehicle. As shown in FIG. 1, the vehicle includes an ISA system 102; an accelerator pedal 104 including an accelerator pedal sensor (APS) 106; and an ECM 108. The APS 106 is configured to provide acceleration signals for indicating to the ECM 108 positions of the accelerator pedal 104 and the ECM is configured to control vehicle acceleration based on the acceleration signals.

As shown in FIG. 1, a mechanical relay 110 of the ISA system 102 is connected in series between the APS 106 and the ECM 108 such that the acceleration signals provided by the APS 106 are routed to the mechanical relay 110. In a default state of the mechanical relay 110, the acceleration signals provided by the APS 106 simply pass through the mechanical relay 110 to the ECM 108 as if the mechanical relay 110 were not there, and the ISA system 102 is essentially bypassed by the acceleration signals provided by the APS 106 and received by the ECM 108. In contrast, in an active state of the ISA system 102, the mechanical relay 110 redirects the acceleration signals from the APS 106 for modification of the acceleration signals if needed to be performed by the ISA system 102 in order to avoid or at least minimize speeding of the vehicle.

Since the mechanical relay 110 of the ISA system 102 is located in series between the APS 106 and the ECM 108, the ISA system 102 essentially intercepts the signals coming from the APS 106 and modulates them before reaching the ECM 108. This enables the ISA system 102 to reduce acceleration and keep the vehicle's speed under the targeted allowed speed limit. Preferably, as the vehicle's speed gets closer to the allowed speed limit, the ISA system 102 progressively reduces the indicated pedal position to the ECM 108 by the acceleration signals, simulating a driver letting up on the accelerator pedal. Once the vehicle speed reaches the target allowed speed limit, the acceleration signals are maintained at the required position to keep that constant speed. Furthermore, the modulation of the signals by the ISA system 102 preferably is only ever a reduction in the indicated accelerator pedal position and never an increase in the indicated accelerator pedal position. The ISA system 102 is configured such that it cannot increase the indicated position of the accelerator pedal position.

The switching of the states of the mechanical relay 110 is effected by a “safety supervisor” module 112. The safety supervisor 112 switches states of the mechanical relay 110 based on communications from a pedal control module 114 of the ISA system 102. Additionally, as a safety precaution, the module 112 is configured to switch the mechanical relay 110 to its default state if active upon a detection of, for example, an error condition or a loss of power to the pedal occurs. Furthermore, the mechanical relay 110 preferably is configured to enter and remain in its default state upon a loss of power to the mechanical relay 110. In accordance with one or more aspects and features of the invention, the pedal control module 114 detects the pedal signal types of the incoming acceleration signals that are used in each implementation. In particular, the APS 106 may provide two analog signals, an analog and a digital signal, or two digital signals. In order to achieve compatibility with a wide variety of different vehicles and, in particular, vehicles with different accelerator position sensors, the ISA system 102 comprises both an analog signal processing circuit 116 for analog APS signals and a digital signal processing circuit 118 for digital APS signals, and the pedal control module 114 determines the types of signals in use by using these circuits 116, 118. Once the signal types are determined, modifications of the APS signals by the pedal control module 114 can be performed using the appropriate signal processing circuit 116,118 for each APS signal.

Modifications are implemented by the pedal control module 114 based on current vehicle speed and an allowed speed limit. The pedal control module 114 is configured to acquire vehicle-related information such as the current vehicle speed, cruise control information, engine RPM, and fuel information by monitoring communications over a controller area network (CAN) of the vehicle through an interface with a data bus of the CAN, which interface is represented by 148. An allowed speed limit is determined and provided to the pedal control module 114 by a speed limit control module 120 of the ISA system 102.

The speed limit control module 120 of the ISA system 102 determines an applicable allowed speed limit for the vehicle based on multiple considerations, which determined applicable allowed speed limit is utilized by the pedal control module 114 in determining whether modification of the acceleration signals provided by the APS 106 are appropriate. In making a determination regarding an applicable allowed speed limit, the speed limit control module 120 relies on both a location analytics module 121 and a vision analytics module 123.

The location analytics module 121 utilizes multiple sensors connected thereto, including a GNSS module 126 and an IMU module 128 and in combination with a location control module 127 determines a current location of the vehicle. The location analytics module 121 includes a map-matching module 136 and a map database 138 which together are used to determine a currently posted speed limit, driving road segment type, and speed zone, if any, based on location data received from the location control module 127. The location analytics module 121 also preferably uses instantaneous location or a series of locations representing trajectory of the vehicle for calculating location of the vehicle, especially when GNSS data may be temporarily unavailable.

The vision analytics module 123 of the speed limit control module 120 utilizes a camera module 130 for acquisition of image data regarding the environment and conditions in which the vehicle is driving. The vision analytics module includes an image data processing module 132 and deep neural networks 134. The image data processing module 132 preferably uses camera image feeds to perform image recognition leveraging the deep neural networks 134 to recognize and perform multiple vision tasks, such as object detection, image segmentation, and image classification. A vision pipeline allows combining the outputs of those networks in real-time to perform downstream tasks such as speed limit sign tracking, road work zone identification, and hazardous road condition detection (rain, snow, ice). The same pipeline could be adapted to detect and track any other objects such as, for instance, vehicle and pedestrian tracking.

Optionally, the vision system takes as an input the estimated location from the location control module and performs a 3D reconstruction of the scene using multi-view geometry, which would output for instance the location of a speed limit sign or road work zone relative to both the car and the world.

It will thus be appreciated that the vision analytics module 123 determines information regarding a current driving environment of the vehicle, which information may include determination of a currently posted speed limit that has been seen, a driving road segment type that has been seen, and a speed zone that has been seen.

The speed limit control module 120 also comprises a fusion module 144 that determines a current driving context based on determinations from the location analytics module 121 and the vision analytics module. The “fusion” of information from both of these modules 121,123 is believed to result in a more accurate determination of the actual current driving context. Both modules 121,123 are not always accurate, and the relative accuracy of each source will depend on individual use cases. Based on the determination of the actual current driving context, the fusion module 144 then determines an allowed (safe) speed limit to apply to the vehicle at that time in accordance with user-configured rules stored in a database 146. Furthermore, the fusion module 144 is designed to always be fail-safe whenever there is insufficient information to make an accurate determination of the actual current driving context, assuming that the driving context is the one that results in identification of the lowest allowed (safe) speed limit to be implemented for the possible driving contexts that could apply, all as disclosed and taught in one or more of the incorporated references.

The speed limit control module 120 and modules and databases associated therewith are preferably configured to receive cloud communications and perform over-the-air (OTA) updates and effect configuration changes through access to a cellular network via a communications module 124. For example, the map data of the database 138 preferably is updated on a regular basis.

In order to avoid possible interference in limiting the speed of the vehicle when the vehicle includes cruise control, the pedal control module 114 preferably is configured to disengage cruise control through an interface represented at 149 to a brake switch simulating control module 122 that is arranged in parallel with a brake switch circuit, as disclosed and taught in one or more of the incorporated references.

In recap of some characteristics of the foregoing preferred ISA system architecture:
The speed limit controller uses multiple sensors such as GNSS, IMU, and camera sensors to determine the driving context and the safe speed limit to apply to the vehicle. If the camera sensor is absent, the system preferably relies on position information that is made available through the GPS and IMU sensor.
The ISA system generally is connected in series between the acceleration pedal sensor (APS) and the ECM of the vehicle.
The pedal controller will automatically detect the incoming pedal signal type (digital or analog pedal) and will modulate the signal to prevent the vehicle from further accelerating if the vehicle is in an overspeed situation.
The pedal controller will deactivate the cruise control through an interface with the brake switch circuit.
The pedal controller will retrieve vehicle-related information (speed, RPM, fuel information) through an interface with the vehicle CAN bus. In an alternative installation, if the vehicle speed information is not available through the can bus of ECM, the vehicle speed can be inferred from the GNSS sensor.
The platform can perform OTA updates and modify platform configuration changes through access to the cellular network.

In operation, the speed limit controller of the ISA system determines in real-time what is the safe maximum speed limit to be applied to the vehicle for a particular driving context. Driving context and the safe speed limit information are determined by combining two information streams which are the vision system and the map-matching system. The vision system uses camera image feeds to perform image recognition leveraging deep neural networks to recognize and perform multiple vision tasks, such as object detection, image segmentation, and image classification. A vision pipeline allows combining the outputs of those networks in real-time to perform downstream tasks such as speed limit sign tracking, road work zone identification, and hazardous road condition detection (rain, snow, ice). The same pipeline could be adapted to detect and track other objects, such as vehicle and pedestrian tracking.

Optionally, the vision system takes as an input the estimated location coming from the location controller and performs a three-dimensional reconstruction of the scene using multi-view geometry. This would output for instance the location of a speed limit sign or road work zone relative to both the car and the world.

Of course, the vision system itself, while preferred, is optional for operations of an ISA system in accordance with aspects and features of the invention. If the camera sensor is absent, then the system relies on positioning information and the map-matching system to determine the relevant maximum speed limit to apply.

The map-matching system takes the output of the location controller as input. The location controller will provide the position of the vehicle by combining sensor data from the IMU and the GPS. Then the map-matching system will apply the location provided by the location controller to an offline map-matching algorithm to determine which road segment the vehicle is most likely on. It can use the instantaneous location or a series of locations representing the trajectory of the vehicle until now to do so. The maps are updated regularly using a cellular data connection (Any high-speed radio such as LTE) or Wi-Fi.

Information from both the map-matching and vision systems can be sent to a fusion system that can leverage data from both systems to make the most accurate decision on the maximum safe speed limit according to the current driving context of the vehicle. Both sources are not always accurate, and the relative accuracy of each source will depend on individual use cases. The fusion system will be designed to always be fail-safe whenever there is not enough information to make an accurate decision on the maximum safe speed limit for a given driving context.

In preferred embodiments of the present invention, the fusion system monitors driver compliance and applies the correct speed limit from either the maximum safe speed limit policy or the reduced maximum speed limit policy for the determined driving context.

Also in preferred embodiments of the present invention, the pedal controller compares the determined applicable speed limit provided by the speed limit controller with the vehicle speed coming from either the ECM or from the GNSS module, if the vehicle speed is absent from the ECM CAN bus. The pedal controller then performs one of the following two actions, if applicable, else does nothing: (1) if the vehicle is over or approaching the determined applicable speed limit and the driver is using the acceleration pedal, the pedal controller modulates the signal to prevent the vehicle from further accelerating; (2) if the vehicle is over the determined applicable speed limit and the driver is using the cruise control, the pedal controller deactivates the cruise control by toggling the brake switch circuit; and (3) if the vehicle is not over the speed limit, then the pedal controller takes no action.

An exemplary speed limit policy is represented in the first table below, and an exemplary speed limit policy is represented in the second table below, both being applicable to a rural state road with no adverse weather conditions.

TABLE 1

| Speed Limit Zone | Maximum Safe Speed Limit |
|---|---|
| Speed Limit 15 | 15 |
| Speed Limit 20 | 20 |
| Speed Limit 25 | 25 |
| Speed Limit 30 | 30 |
| Speed Limit 35 | 35 |
| Speed Limit 40 | 40 |
| Speed Limit 45 | 45 |
| Speed Limit 50 | 50 |
| Speed Limit 55 | 55 |
| Speed Limit 60 | 60 |
| Speed Limit 65 | 65 |
| Speed Limit 70 | 70 |
| Speed Limit 75 | 70 |
| Speed Limit 80 | 70 |

TABLE 2

| Speed Limit Zone | Reduced Maximum Speed Limit |
|---|---|
| Speed Limit 15 | 15 |
| Speed Limit 20 | 20 |
| Speed Limit 25 | 25 |
| Speed Limit 30 | 30 |
| Speed Limit 35 | 35 |
| Speed Limit 40 | 40 |
| Speed Limit 45 | 45 |
| Speed Limit 50 | 50 |
| Speed Limit 55 | 50 |
| Speed Limit 60 | 55 |
| Speed Limit 65 | 55 |
| Speed Limit 70 | 55 |
| Speed Limit 75 | 55 |
| Speed Limit 80 | 55 |

In the context of the foregoing preferred ISA system architecture and operation, different aspects and features of the invention will now be described with reference to preferred embodiments.

While the speed policies described above are predetermined by a fleet operator based on driving contexts, speed policies also can be based on geofenced areas. For instance, a geofenced area can be defined around a construction site, industrial site, or warehouse, for example. Such a geofenced area and both a maximum safe speed limit policy and a reduced maximum speed limit policy for such geofenced area can be defined by a fleet operator for use that would take priority over speed policies defined for driving contexts. As an example, a maximum safe speed limit policy for a geofenced area may define the applicable allowed speed limit by the ISA system to be 10 mph, and a reduced maximum speed limit policy for a geofenced area may define the applicable allowed speed limit by the ISA system to be 5 mph.

### Compliance With Fleet Policy regarding Seatbelt Use

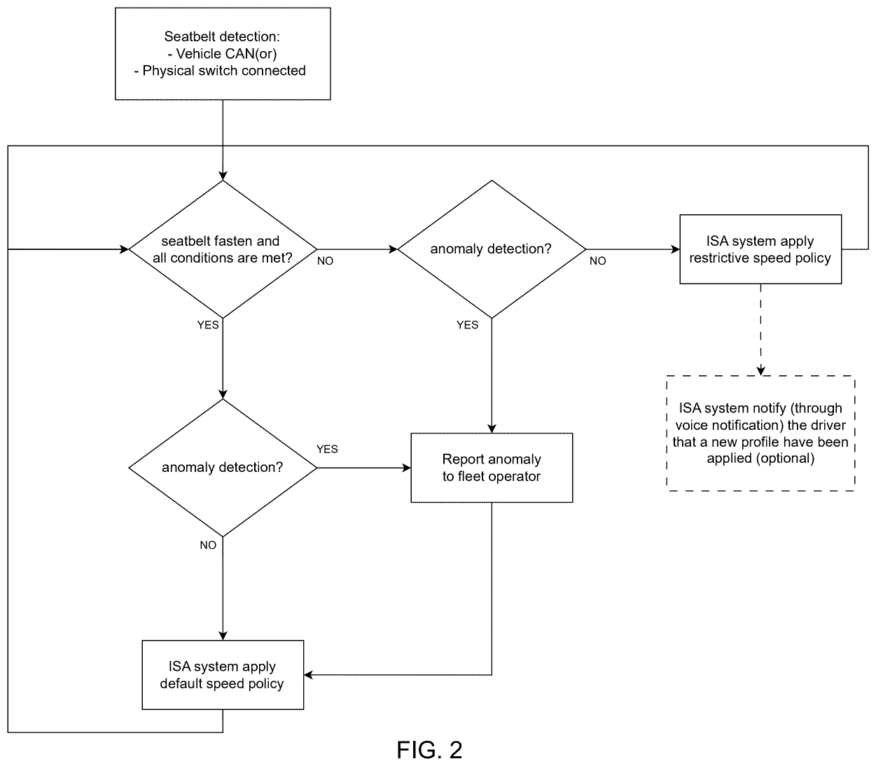

FIG. 2 illustrates a preferred workflow of an ISA system that monitors seatbelt use and applies an appropriate fleet-determined speed limit policy based thereon.

As illustrated, the ISA system detects a seatbelt status from either the vehicle CAN communication network or from a physical switch interface between the seatbelt itself and the ISA system harness. The ISA system evaluates if the seatbelt is fastened and all the operating conditions of the vehicle such as: how long the vehicle has been moving: whether the driver is sitting in his seat; and whether the vehicle is inside a geofenced area or on the road. The ISA system also evaluates if any anomaly is detected around the seatbelt monitoring. An anomaly can be such as: whether there is frequent buckling and un-buckling: whether the seatbelt is buckled even if the vehicle has been parked for a long time: and whether the seatbelt is buckled but the driver seat is indicated to be empty. If any anomaly is detected, this could mean either a malfunction of the system or a driver trying to cheat the system. The system will thus report the anomaly to the fleet operator through the cellular network connectivity and display it on a web portal. If no anomaly is detected, then the ISA system applies the determined applicable speed limit as determined from the maximum safe speed limit policy for the geofenced area or the driving context, or as determined from the reduced maximum speed limit policy if the driver is determined to be driving without using the seatbelt in noncompliance with the fleet's policy regarding use of the seatbelt.

Optionally the ISA system may notify the driver through voice notification that the reduced maximum speed limit policy has been applied based on the driver's noncompliance. Furthermore, the foregoing seatbelt monitoring workflow continuously loops as long as the vehicle engine is running.

### Compliance With Fleet Policy Regarding Idling

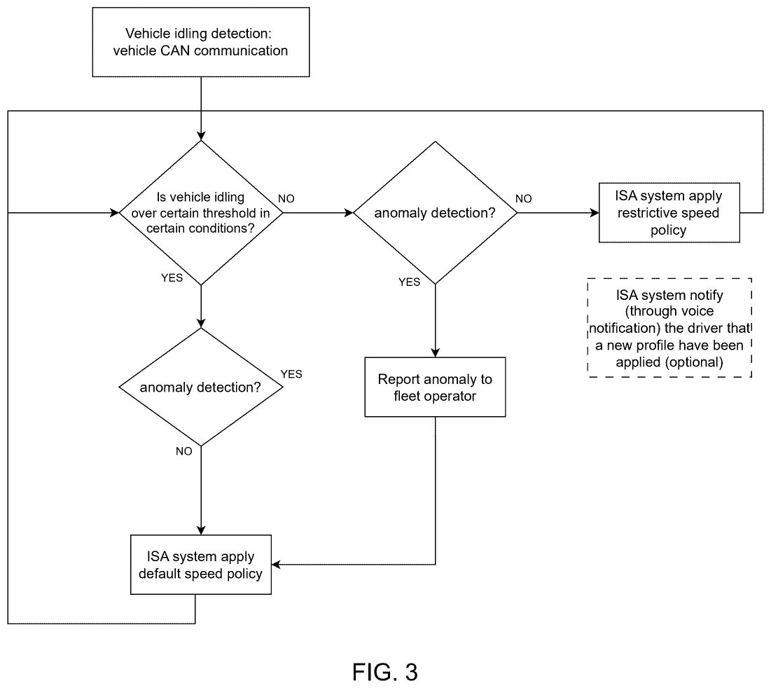

FIG. 3 illustrates a preferred workflow in which idling status is monitored and the ISA system applies an appropriate fleet-determined speed limit policy based thereon. Within this context, there are two preferred implementations: one in which vehicle idling monitoring is done locally by the ISA system, and another in which vehicle idling monitored is done remotely. FIG. 3 illustrates the first preferred implementation, in which the ISA system both performs the monitoring of the vehicle idling status and determines and applies the corresponding speed limit policy.

In the first preferred implementation, the ISA system monitors the vehicle's idling status from the vehicle CAN bus network. The ISA system keeps a local record of all the idling occurrences that happen over a certain period including other environmental parameters such as vehicle exterior temperature. The ISA system then evaluates if the vehicle is idling over a certain threshold for the certain period. Depending on the fleet policy, some idling occurrences above or below a certain threshold can be excluded from the calculation based on, for example, the detected exterior temperature. The ISA system also evaluates if any anomaly is detected around the idling monitoring. An anomaly can be for example: a large idling percentage variation between two periods: and a large idling fuel consumption between two periods. If any anomaly is detected, this could mean either a malfunction of the system or a driver trying to cheat the system. The system thus reports the anomaly to the fleet operator through the cellular network connectivity and displays it on a web portal. If no anomaly is detected, then the ISA system determines and applies the corresponding applicable allowed speed limit, which is dependent on whether the vehicle has been idling above a certain threshold.

Optionally the ISA system notifies the driver through voice notification when a new speed limit policy is applied. Furthermore, the foregoing idling monitoring workflow continuously loops as long as the vehicle engine is running.

In situations where a fleet has complex operational constraints to consider, the ISA system or any other telematic device can report the idling occurrences through the cellular network to an external cloud-based system. Such a remote, centralized system then can more efficiently monitor and calculate whether a given vehicle is idling over a given threshold and communicate that information back to the ISA system of the vehicle. Once the ISA system has received the most recent idling status, the ISA system can apply the corresponding applicable allowed speed limit, which is dependent on whether the vehicle has been idling above a certain threshold. The advantage of this approach is that fleets have complex operational constraints to take into account when calculating whether the idling threshold has been met or exceeded, and it is much easier to update the business logic of the external system than updating the business logic at the ISA system level. This flexibility allows fleets to dynamically adjust their internal policies and keep the ISA system as an actuator when a driver is not following a fleet policy.

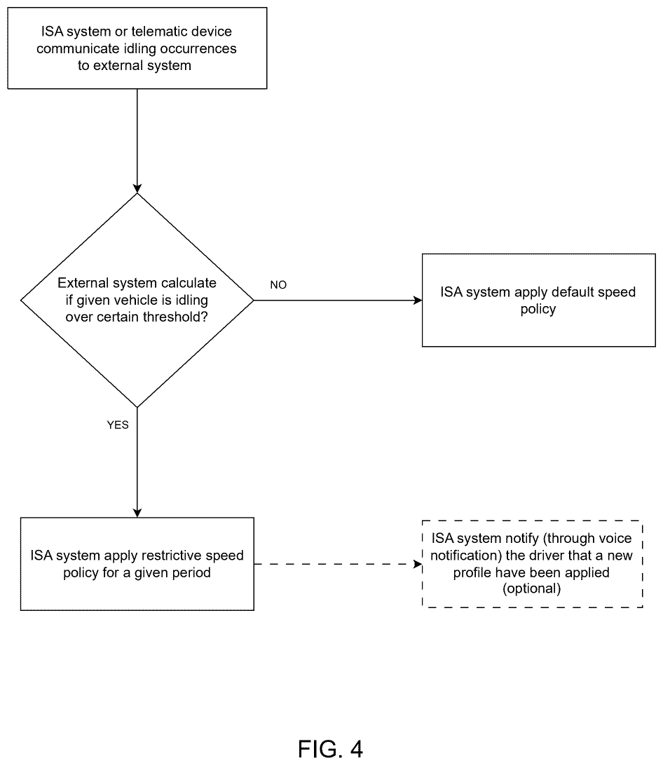

FIG. 4 illustrates this second preferred implementation, in which the ISA system determines and applies the corresponding speed limit policy based on the calculated idling threshold. In the first step, the ISA system or any other telematic device communicates to the external system over the cellular network all the idling occurrences of the vehicle. The external system considers all the idling occurrences over a given period and calculates whether a given vehicle has exceeded the allowed threshold of idling fuel percentage. If the external system has identified that a vehicle has exceeded the idling fuel percentage, then the external system updates through the API the ISA system for using the maximum allowed speed limit policy for a given period. Preferably, the given period is for a plurality of days, such as a week.

Optionally the ISA system notifies the driver through voice notification when a new speed limit policy is applied. Furthermore, the foregoing idling monitoring workflow continuously loops as long as the vehicle engine is running.

### Compliance With Fleet Policy Regarding Out-of-Route Travel

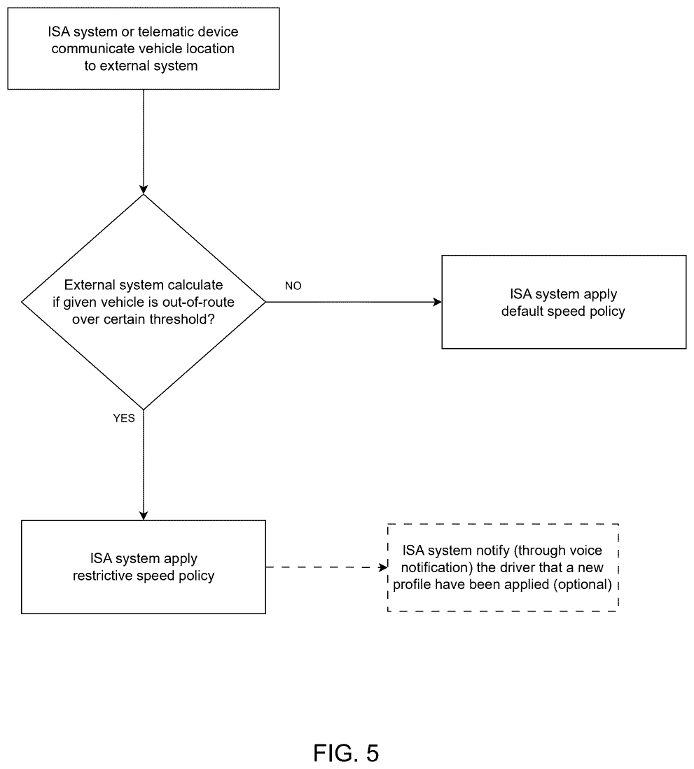

FIG. 5 illustrates a preferred workflow in which out-of-route travel is monitored and the ISA system applies an appropriate fleet-determined speed limit policy based thereon. Within this context, the ISA system communicates the vehicle location to an external system at regular intervals, and the external system determines whether the given vehicle is out of route and the extent thereof.

In particular, in a first step the ISA system or any other telematic device communicates to the external system over the cellular network the vehicle location at regular intervals. The external system compares the vehicle location with the most up-to-date approved vehicle route and determines if the vehicle is out-of-route. If the external system identifies that a vehicle has exceeded an out-of-route cumulative threshold distance, then external system updates the ISA system settings through API, whereupon the ISA system applies the reduced maximum speed limit policy applicable to the driving context for a given period of time and/or until the vehicle has no exceeded the out-of-route cumulative threshold distance.

Optionally the ISA system notifies the driver through voice notification when a new speed limit policy is applied. Furthermore, the foregoing idling monitoring workflow continuously loops as long as the vehicle engine is running.

As will be appreciated, embodiments in accordance with one or more aspects and features of the invention provide an innovative way for fleet operators to enforce fleet policies by leveraging ISA systems. Moreover, it will be appreciated that an ISA system can enforce one or multiple fleet policies concurrently, with the lowest determined applicable speed limit being used by the ISA system for a given driving context or geofenced area.

Based on the foregoing description, it will be readily understood by those persons skilled in the art that the invention has broad utility and application. Many embodiments and adaptations of the invention other than those specifically described herein, as well as many variations, modifications, and equivalent arrangements, will be apparent from or reasonably suggested by the invention and the foregoing descriptions thereof, without departing from the substance or scope of the invention.

Accordingly, while the invention has been described herein in detail in relation to one or more preferred embodiments, it is to be understood that this disclosure is only illustrative and exemplary of the invention and is made merely for the purpose of providing a full and enabling disclosure of the invention. The foregoing disclosure is not intended to be construed to limit the invention or otherwise exclude any such other embodiments, adaptations, variations, modifications or equivalent arrangements, the invention being limited only by the claims appended hereto and the equivalents thereof.

1-6. (canceled)

7. A method of determining, by an ISA system, a reduced maximum speed limit instead of a maximum safe speed limit as being an applicable speed limit as a function of driver noncompliance.

8. The method of claim 7, wherein the reduced maximum speed limit is less than the maximum safe speed limit.

9. An intelligent speed adaptor (ISA) system configured to determine a reduced maximum speed limit instead of a maximum safe speed limit as being an applicable speed limit as a function of driver noncompliance.

10. The ISA system of claim 9, wherein the reduced maximum speed limit is less than the maximum safe speed limit.

11-13. (canceled)
